(19) United States
(12) Patent Application Publication
(10) Pub. No.: US 2021/0099085 A1
(43) Pub. Date: Apr. 1, 2021

(54) SWITCH CAPACITOR CONVERTER

(71) Applicant: SILICON MITUS, INC, Seongnam-si (KR)

(72) Inventor: Kin Keung LAU, Redwood City, CA (US)

(73) Assignee: SILICON MITUS, INC, Seongnam-si (KR)

(21) Appl. No.: 16/991,742

(22) Filed: Aug. 12, 2020

(30) Foreign Application Priority Data
Sep. 27, 2019 (KR) 10-2019-0119534

(51) Int. Cl. H02M 3/158; H02M 3/07; H03H 19/00

(52) U.S. Cl. CPC H02M 3/158; H02M 2001/0003; H03H 19/004; H02M 3/07

(57) ABSTRACT

The present disclosure relates to a switch capacitor converter with high efficiency and a small size. The converter according to one aspect of the present disclosure is provided for receiving an input voltage through an input terminal and supplying an output voltage through an output terminal, the converter comprising: a first capacitor; a second capacitor; a third capacitor; and a switch network for changing a connection relationship between the input terminal, the output terminal, the first capacitor, the second capacitor, and the third capacitor. A ratio of the input voltage to the output voltage implemented in the converter is selectable from 4:1, 3:1, or 2:1 depending on an operation of the switch network.

### CROSS REFERENCE TO RELATED APPLICATION

This application claims priority from Korean Patent Application No. 10-2019-0119534, filed on Sep. 27, 2019, which is hereby incorporated by reference for all purposes as if fully set forth herein.

### TECHNICAL FIELD

The present disclosure relates to switch capacitor converters, and more particularly, to switch capacitor power converters with a pre-configured voltage conversion ratio.

### BACKGROUND ART

As the power consumption of mobile systems (e.g., smart phones, tablets, or the like) continues to increase in recent years, and the operating voltages of components (e.g., cores, related circuits, or the like) that consume power in the mobile systems tend to decrease, there is a growing need for converters with a voltage conversion ratio (i.e. a ratio of an input voltage to an output voltage) exceeding 2:1.

A switch capacitor converter is generally used as a type of the converters with the voltage conversion ratio of 2:1 in the mobile systems. The switch capacitor converter is a circuitry in which typically, at least one capacitor and at least one semiconductor switching element (hereinafter, for convenience of description, referred to as “switch”) are combined without using an inductor. The switch capacitor converter may be understood as a circuitry for changing a relationship between an input voltage and an output voltage by changing an electrical connection to one or more capacitors through the on/off operation of the at least one switch. Considering that studies on a switch capacitor converter including a small-sized inductor are in progress, the switch capacitor converter may not be needed to be defined as a converter not including an inductor. It should be noted that generally, the switch capacitor converter may reduce its size and achieve increased efficiency by not using a large-sized inductor.

However, in the case of a voltage conversion ratio of exceeding 2:1, for example, a voltage conversion ratio of 4:1, a size of the switch capacitor converter increases, and efficiency of the converter reduces, due to increased voltage stresses of the switch and the capacitor, and an increased number of components.

For example, a method of implementing the voltage conversion ratio of 4:1 by electrically connecting two switch capacitor converters with the voltage conversion ratio of 2:1 in series is known, but this method has a problem of causing an increased power loss.

As another example, in the case of a 4:1 Dickson switch capacitor converter illustrated in FIG. 23, a disadvantage of this converter is that a capacitor Ca with a breakdown voltage being three times an output voltage Vo and a capacitor Cb with a breakdown voltage being two times an output voltage Vo are needed. A high breakdown voltage capacitor is disadvantageous in size and efficiency due to an increased size and a small effective capacitance.

Further, there is a growing need for a circuitry that can be operable in a voltage conversion ratio exceeding 2:1 and can adjust the voltage conversion ratio. Although some circuitries capable of adjusting the voltage conversion ratio by using an increased number of switches and/or capacitors are known, however, this presents disadvantages in size and efficiency due to an increased number of switches and/or capacitors.

### DETAILED DESCRIPTION OF THE INVENTION

### Technical Problem

It is an object of the present disclosure to provide a switch capacitor converter with high efficiency and a small size.

It is another object of the present disclosure to provide a switch capacitor converter capable of adjusting a conversion ratio of an input voltage to an output voltage.

It is further another object of the present disclosure to provide a switch capacitor converter that is configured in a binary manner and can be extended to have a higher voltage conversion ratio.

It is yet another object of the present disclosure to provide a switch capacitor converter which operates, in an interleaving manner, two switch capacitor converter modules that are connected in parallel and enables capacitors between the two modules to be integrated.

### Technical Solution

In accordance with one aspect of the present disclosure, a converter is provided for receiving an input voltage through an input terminal and supplying an output voltage through an output terminal, the converter comprising: a first switch capacitor network in which i) a first switch, a first capacitor, and a second switch are connected in series, ii) a first terminal of the first switch is connected to the input terminal, and iii) a second terminal of the second switch is connected to a reference voltage; a second switch capacitor network in which i) a third switch, a second capacitor, and a fourth switch are connected in series, ii) a first terminal of the third switch is connected to a first terminal of the first capacitor, and iii) a second terminal of the fourth switch is connected to the reference voltage; a third switch capacitor network in which i) a fifth switch, a third capacitor, and a sixth switch are connected in series, ii) a first terminal of the fifth switch is connected to a second terminal of the first capacitor, and iii) a second terminal of the sixth switch is connected to the reference voltage; and an output switch network including a seventh switch and an eighth switch which are connected in series and a ninth switch and a tenth switch which are connected in series, in which i) a first terminal of the seventh switch and a second terminal of the eighth switch are connected to both terminals of the second capacitor respectively, ii) a first terminal of the ninth switch and a second terminal of the tenth switch are connected to both terminals of the third capacitor respectively, and iii) a connection point of the seventh switch and the eighth switch and a connection point of the ninth switch and the tenth switch are connected together to the output terminal.

In this converter, a ratio of the input voltage to the output voltage may be changed during the operation of the converter.

In a first state of a 4:1 mode, the first, fourth, fifth, seventh, and tenth switches are turned on, and the second, third, sixth, eighth, and ninth switches are turned off. In a second state of the 4:1 mode, the second, third, sixth, eighth, and ninth switches are turned on, and the first, fourth, fifth, seventh, and tenth switches are turned off. Therefore, the converter may operate so that a ratio of the input voltage to the output voltage substantially becomes 4:1.

In a first state of a 3:1 mode, the first, fifth, and tenth switches are turned on, and the second, third, fourth, sixth, seventh, eighth, and ninth switches are turned off. In a second state of the 3:1 mode, the second, third, sixth, seventh, and ninth switches are turned on, and the first, fourth, fifth, eighth, and tenth switches are turned off. Therefore, the converter may operate so that a ratio of the input voltage to the output voltage substantially becomes 3:1.

In a first state of the 2:1 mode, the first, third, fifth, eighth, and ninth switches are turned on, and the second, fourth, sixth, seventh, and tenth switches are turned off. In a second state of the 2:1 mode, the second, third, fourth, and seventh switches are turned on, and the first, fifth, sixth, eighth, ninth, and tenth switches are turned off. Therefore, the converter may operate so that a ratio of the input voltage to the output voltage substantially becomes 2:1.

In accordance with another aspect of the present disclosure, a converter is provided for receiving an input voltage through an input terminal and supplying an output voltage through an output terminal, the converter comprising: a first capacitor; a second capacitor; a third capacitor; and a switch network for changing a connection relationship between the input terminal, the output terminal, the first capacitor, the second capacitor, and the third capacitor. A ratio of the input voltage to the output voltage implemented in the converter may be selected from 4:1, 3:1, or 2:1 depending on an operation of the switch network.

In this converter, in a first state of the 4:1 mode, i) a first terminal of the first capacitor is connected to the input terminal, ii) a second terminal of the first capacitor is connected to a first terminal of the third capacitor, iii) a second terminal of the third capacitor is connected to a first terminal of the second capacitor and the output terminal, and iv) a second terminal of the second capacitor is connected to a reference voltage. In a second state of the 4:1 mode, i) the first terminal of the first capacitor is connected to the first terminal of the second capacitor, ii) the second terminal of the first capacitor is connected to the reference voltage, iii) the second terminal of the second capacitor is connected to the first terminal of the third capacitor and the output terminal, and iv) the second terminal of the third capacitor is connected to the reference voltage. Therefore, the converter may operate so that a ratio of the input voltage to the output voltage substantially becomes 4:1.

In a first state of the 3:1 mode, i) a first terminal of the first capacitor is connected to the input terminal, ii) a second terminal of the first capacitor is connected to a first terminal of the third capacitor, iii) and a second terminal of the third capacitor is connected to the output terminal. In a second state of the 3:1 mode, i) the first terminal of the first capacitor and the first terminal of the third capacitor is connected to the output terminal, ii) and the second terminal of the first capacitor and the second terminal of the third capacitor are connected to the reference voltage. Therefore, the converter may operate so that a ratio of the input voltage to the output voltage substantially becomes 3:1.

In a first state of the 2:1 mode, i) a first terminal of the first capacitor and a first terminal of the second capacitor are connected to the input terminal, ii) and a second terminal of the first capacitor and a second terminal of the second capacitor are connected to the output terminal. In a second state of the 2:1 mode, i) the first terminal of the first capacitor and the first terminal of the second capacitor are connected to the output terminal, ii) and the second terminal of the first capacitor and the second terminal of the second capacitor are connected to the reference voltage. Therefore, the converter may operate so that a ratio of the input voltage to the output voltage substantially becomes 2:1.

In this converter, a ratio of the input voltage to the output voltage may be changed during the operation of the converter.

In accordance with further another aspect of the present disclosure, a converter is provided for receiving an input voltage through an input terminal and supplying an output voltage through an output terminal, the converter comprising: a first, a second, a third, a fourth, a fifth, a sixth, a seventh, an eighth, a ninth, and a tenth switches; and a first, a second, and a third capacitors. In the converter, i) a first terminal of the first switch is connected to the output terminal, ii) a second terminal of the first switch is connected to a first terminal of the first capacitor and a first terminal of the third switch, iii) a second terminal of the first capacitor is connected to a first terminal of the second switch and a first terminal of the fifth switch, iv) a second terminal of the fifth switch is connected to a first terminal of the third capacitor and a first terminal of the ninth switch, v) a second terminal of the third capacitor is connected to a first terminal of the sixth switch and a second terminal of the tenth switch, vi) a second terminal of the ninth switch is connected to a first terminal of the tenth switch, the output terminal, a second terminal of the seventh switch, and a first terminal of the eighth switch, vii) a second terminal of the third switch is connected to a first terminal of the seventh switch and a first terminal of the second capacitor, viii) a second terminal of the second capacitor is connected to a second terminal of the eighth switch and a first terminal of the fourth switch, and ix) a second terminal of the second switch, a second terminal of the sixth switch, and a second terminal of the fourth switch are connected to the reference voltage.

In this converter, a plurality of switching components in at least one of the first to tenth switches can be connected in series and/or in parallel.

A plurality of capacitors in at least one of the first to third capacitors can be connected in series and/or in parallel.

In accordance with yet another aspect of the present disclosure, a converter is provided for receiving an input voltage through an input terminal and supplying an output voltage through an output terminal, the converter comprising: a first switch capacitor converter module including a switch and a capacitor; and a second switch capacitor converter module including a switch and a capacitor and sharing the input terminal and the output terminal with the first switch capacitor converter module.

In this converter, the first switch capacitor converter module and the second switch capacitor converter module can be configured with an equal circuitry to each other and operate in an interleaving manner.

The first switch capacitor converter module and the second switch capacitor converter module can share at least one capacitor and/or at least one switch with each other.

Each of the first switch capacitor converter module and the second switch capacitor converter module can comprise: a first switch capacitor network in which i) a first switch, a first capacitor, and a second switch are connected in series, ii) a first terminal of the first switch is connected to the input terminal, and iii) a second terminal of the second switch is connected to a reference voltage; a second switch capacitor network in which i) a third switch, a second capacitor, and a fourth switch are connected in series, ii) a first terminal of the third switch is connected to a first terminal of the first capacitor, and iii) a second terminal of the fourth switch is connected to the reference voltage; a third switch capacitor network in which i) a fifth switch, a third capacitor, and a sixth switch are connected in series, ii) a first terminal of the fifth switch is connected to a second terminal of the first capacitor, and iii) a second terminal of the sixth switch is connected to the reference voltage; and an output switch network including a seventh switch and an eighth switch which are connected in series and a ninth switch and a tenth switch which are connected in series, in which i) a first terminal of the seventh switch and a second terminal of the eighth switch are connected to both terminals of the second capacitor respectively, ii) a first terminal of the ninth switch and a second terminal of the tenth switch are connected to both terminals of the third capacitor respectively, and iii) a connection point of the seventh switch and the eighth switch and a connection point of the ninth switch and the tenth switch are connected together to the output terminal.

In this converter, a line for connecting the second capacitor of the first switch capacitor converter module and the third capacitor of the second switch capacitor converter module in parallel can be added between the first switch capacitor converter module and the second switch capacitor converter module. At least one of integration of the second capacitor of the first switch capacitor converter module and the third capacitor of the second switch capacitor converter module, integration of the seventh switch of the first switch capacitor converter module and the ninth switch of the second switch capacitor converter module, and integration of the eighth switch of the first switch capacitor converter module and the tenth switch of the second switch capacitor converter module can be applied to the converter.

A line for connecting the third capacitor of the first switch capacitor converter module and the second capacitor of the second switch capacitor converter module in parallel can be added between the first switch capacitor converter module and the second switch capacitor converter module. At least one of integration of the third capacitor of the first switch capacitor converter module and the second capacitor of the second switch capacitor converter module, integration of the ninth switch of the first switch capacitor converter module and the seventh switch of the second switch capacitor converter module, and integration of the tenth switch of the first switch capacitor converter module and the eighth switch of the second switch capacitor converter module can be applied to the converter.

In accordance with yet another aspect of the present disclosure, a converter is provided for receiving an input voltage through an input terminal and supplying an output voltage through an output terminal, the converter comprising an N number of stages and an output stage, and operating so that a ratio of the input voltage to the output voltage can become 2^{N}:1. In this converter, i) a first stage of an N number of stages includes two base switch networks and two capacitors, ii) each of a second stage to a Nth stage of the N number of stages includes four base switch networks and two capacitors, iii) the output stage includes an output switch network, iv) each of the base switch networks includes a first switch connected between a first node and a second node and a second switch connected between a third node and a reference voltage, v) and at least one of capacitors included in an identical stage is connected between the second node and the third node.

In this converter, each of four base switch networks included in a kth stage (k is one of 2, 3, . . . , N) can be independently connected to one terminal of two capacitors of a (k−1)th stage so that at least two of the four base switch networks cannot be commonly connected to one terminal of the two capacitors.

In this converter, respective two of four base switch networks included in the kth stage (k is one of 2, 3, . . . , N) can share a capacitor with each other.

The output switch network includes four switches. A first terminal of each of the four switches of the output switch network can be independently connected to one terminal of two capacitors of the Nth stage. That is, at least two of respective first terminals of the four switches are not connected together to one terminal of two capacitors of the Nth stage. Respective second terminals of the four switches can be commonly connected to the output terminal.

### Effects of the Invention

In accordance with embodiments of the present disclosure, it is possible to provide a switch capacitor converter with high efficiency and a small size.

In accordance with embodiments of the present disclosure, it is possible to provide a switch capacitor converter capable of adjusting a conversion ratio of an input voltage to an output voltage.

In accordance with embodiments of the present disclosure, it is possible to provide a switch capacitor converter that is configured in a binary manner and can be extended to have a higher voltage conversion ratio.

In accordance with embodiments of the present disclosure, it is possible to provide a switch capacitor converter which operates, in an interleaving manner, two switch capacitor converter modules that are connected in parallel and enables capacitors between the two modules to be integrated.

### BRIEF DESCRIPTION OF THE DRAWINGS

FIG. 1 illustrates a switch capacitor converter according to embodiments of the present disclosure.

FIGS. 2a, 2b, 3a and 3b illustrate a 4:1 voltage conversion operation of the switch capacitor converter illustrated in FIG. 1.

FIGS. 4a, 4b, 5a and 5b illustrate a 3:1 voltage conversion operation of the switch capacitor converter illustrated in FIG. 1.

FIGS. 6a, 6b, 7a and 7b illustrate a 2:1 voltage conversion operation of the switch capacitor converter illustrated in FIG. 1.

FIG. 8 is a diagram illustrating a switch capacitor converter using two switch capacitor converter modules in parallel according to embodiments of the present disclosure.

FIG. 9 is a diagram illustrating a switch capacitor converter in which the switch capacitor converter illustrated in FIG. 1 is applied to each module according to embodiments of the present disclosure.

FIGS. 10 and 11 illustrate a 4:1 voltage conversion operation of the switch capacitor converter illustrated in FIG. 9.

FIGS. 12 and 13 illustrate a 3:1 voltage conversion operation of the switch capacitor converter illustrated in FIG. 9.

FIGS. 14 and 15 illustrate a 2:1 voltage conversion operation of the switch capacitor converter illustrated in FIG. 9.

FIG. 16 illustrates an example of integrating one or more capacitor(s) and/or one or more switch(s) between two modules included in the switch capacitor converter illustrated in FIG. 9 according to embodiments of the present disclosure.

FIG. 17 illustrates an example of dividing the switch capacitor converter illustrated in FIG. 1 into three switch capacitor converters and one output switch network.

FIG. 18 illustrates that a switch capacitor network is configured by a combination of a base switch network and a capacitor.

FIG. 19 illustrates a structure of the output switch network.

FIG. 20 is a diagram illustrating a 2²:1 switch capacitor converter in which one or more switch(s) and one or more capacitor(s) of two switch capacitor converter modules are integrated according to embodiments of the present disclosure.

FIG. 21 is a diagram illustrating a 2³:1 switch capacitor converter in which one or more switch(s) and one or more capacitor(s) of two switch capacitor converter modules are integrated according to embodiments of the present disclosure.

FIG. 22 is a diagram illustrating a 2^{N}:1 switch capacitor converter in which one or more switch(s) and one or more capacitor(s) of two switch capacitor converter modules are integrated according to embodiments of the present disclosure.

FIG. 23 illustrates a 4:1 Dickson switch capacitor converter.

FIGS. 24a, 24b, 25a and 25b Illustrate an operation of the 4:1 Dickson switch capacitor converter illustrated in FIG. 23.

### BEST MODE FOR CARRYING OUT THE INVENTION

Hereinafter, embodiments of the present disclosure will be described in detail with reference to the accompanying drawings. In adding reference numerals to elements in each drawing, the same elements will be designated by the same reference numerals, if possible, although they are shown in different drawings. Further, in the following description of the present disclosure, a detailed description of known functions and configurations incorporated herein will be omitted when it is determined that the description may make the subject matter of the present disclosure rather unclear.

Terms, such as first, second, A, B, (A), or (B) may be used herein to describe elements of the disclosure. Each of the terms is not used to define essence, order, sequence, or number of an element, but is used merely to distinguish the corresponding element from another element. When it is mentioned that an element is “connected” or “coupled” to another element, it should be interpreted that another element may be “interposed” between the elements or the elements may be “connected” or “coupled” to each other via another element as well as that one element is directly connected or coupled to another element.

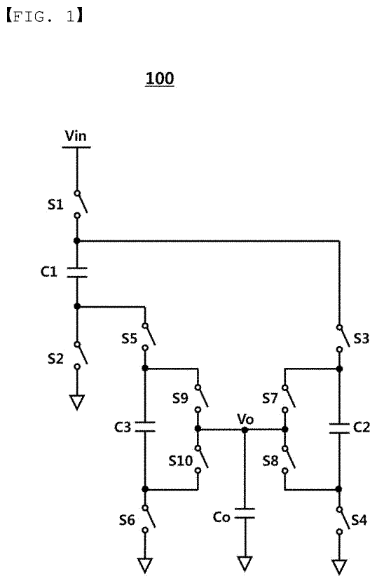

FIG. 1 illustrates a switch capacitor converter 100 according to embodiments of the present disclosure.

The switch capacitor converter 100 may be used for converting power in a system of an electronic device including a smart phone, a tablet, or the like.

The switch capacitor converter 100 can receive an input voltage Vin through an input terminal and supply an output voltage Vo through an output terminal. The input voltage Vin may be a voltage supplied from a charger outside of the system, or a voltage supplied from any node in a power network inside of the system. The switch capacitor converter 100 can generate the output voltage Vo having a certain ratio to the input voltage vin, and output to the outside of the system or any node in the power network inside of the system. In FIG. 1, although it is illustrated that an output capacitor Co is included in the switch capacitor converter 100, the output capacitor Co may be an internal component included in the switch capacitor converter 100 or an external component not included in the switch capacitor converter 100.

The switch capacitor converter 100 may operate so that a voltage conversion ratio (a ratio of an input voltage to an output voltage) can substantially become 4:1. Alternatively, a voltage conversion ratio of the switch capacitor converter 100 may be substantially one of 4:1, 3:1, or 2:1. That is, the switch capacitor converter 100 may be changeable to one of 4:1, 3:1, or 2:1.

Here, the term “substantially” means that, even when the switch capacitor converter 100 is designed to have the voltage conversion ratio of 4:1 and operates in this ratio, an actual ratio of the input voltage to the output voltage may have a slight margin of error at 4:1 due to an influence of circuit parasitics of circuit components, a margin of error of a controller, or the like. Herein, it should be therefore understood that, even when the term “substantially” is not described, the voltage conversion ratio, voltage stresses of components, or the like may have the margin of error.

Each of the input terminal and the output terminal is not limited to a specific shape or a specific connection manner. Any terminal connected to the input voltage Vin may be understood as an input terminal, and any terminal connected to the output voltage Vo may be understood as an output terminal.

The switch capacitor converter 100 can include a first capacitor C1, a second capacitor C2, a third capacitor C3 and switch networks (S1˜S10).

The switch networks (S1˜S10) can change a connection relationship between two or more of the input terminal, the output terminal, the first capacitor C1, the second capacitor C2 and the third capacitor C3. The voltage conversion ratio may be selected from 4:1, 3:1, or 2:1 depending on an operation of one or more switch networks (S1˜S10). In some embodiments, the voltage conversion ratio may be changed during the operation of the switch capacitor converter 100.

A circuit configuration of the switch capacitor converter 100 is described in detail. A first terminal of the first switch S1 (the upper and lower terminals in FIG. 1 which are two terminals of the first switch S1 are referred to as first and second terminals, respectively. Hereinafter, this defining is equally applied to other drawings and other components) can be connected to the input terminal, and a second terminal of the first switch S1 can be connected to a first terminal of the first capacitor C1 and a first terminal of the third switch S3. A second terminal of the first capacitor C1 can be connected to a first terminal of the second switch S2 and a first terminal of the fifth switch S5. A second terminal of the fifth switch S5 can be connected to a first terminal of the third capacitor C3 and a first terminal of the ninth switch S9. A second terminal of the third capacitor C3 can be connected to a first terminal of the sixth switch S6 and a second terminal of the tenth switch S10. A second terminal of the ninth capacitor S9 can be connected to a first terminal of the tenth switch S10, the output terminal, a second terminal of the seventh switch S7, and a first terminal of the eighth switch S8. A second terminal of the third capacitor S3 can be connected to a first terminal of the seventh switch S7 and a first terminal of the second capacitor C2. A second terminal of the second capacitor C2 can be connected to a second terminal of the eighth switch S8 and a first terminal of the fourth switch S4. A second terminal of the second switch S2, a second terminal of the sixth switch S6 and a second terminal of the fourth switch S4 can be connected to a reference voltage (e.g., ground or grounded).

Here, a plurality of switching components in at least one of the first switch S1 to the tenth switch S10 can be connected in series and/or in parallel. Further, a plurality of capacitors in at least one of the first capacitor C1 to the third capacitor C3 can be connected in series and/or in parallel. That is, each of the switches (S1˜S10) and each of the capacitors (C1˜C3) illustrated in FIG. 1 may include a plurality of components that can operate as one component. Herein, in discussing the number of switches, it can be understood that an instance where a plurality of switches is connected in series and/or in parallel and then operates as one switch is regarded as the using of one switch. This defining is equally applied to a configuration of the capacitor(s).

The first switch S1 to the tenth switch S10 can be implemented as typical semiconductor switching components. For example, the first switch S1 to the tenth switch S10 can be implemented as semiconductor switching components capable of operating with a high speed, such as FET, IGBT, MCT, GTO, BJT, and the like.

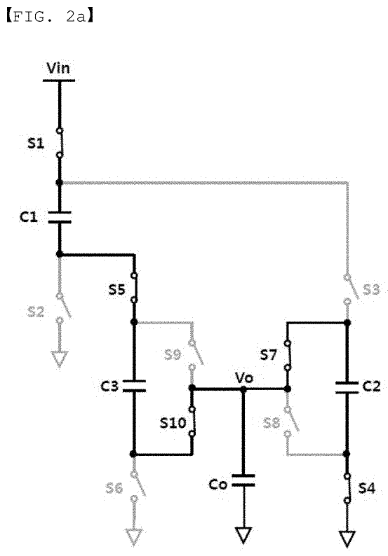

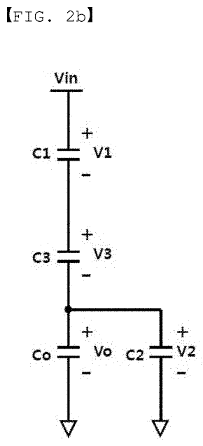

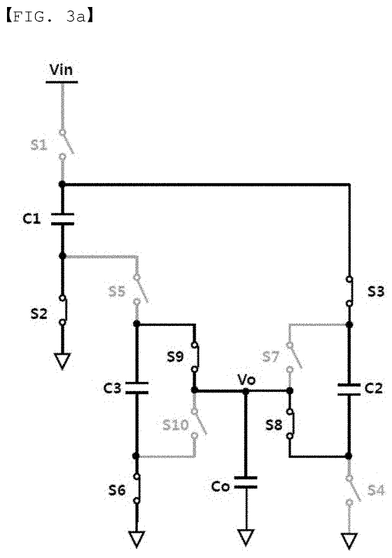

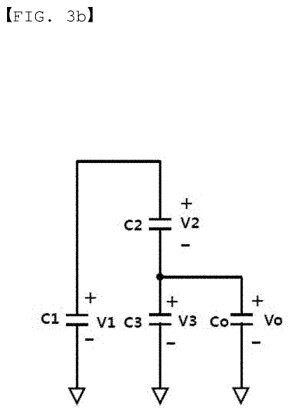

FIGS. 2 and 3 illustrate that the switch capacitor converter 100 illustrated in FIG. 1 operates in a 4:1 voltage conversion.

FIG. 2a illustrates a switch connection state in a first state (state 1) of the 4:1 mode, and FIG. 2b equivalently illustrates a connection relationship of capacitors in the first state of the 4:1 mode. FIG. 3a illustrates a switch connection state in a second state (state 2) of the 4:1 mode, and FIG. 3b equivalently illustrates a connection relationship of capacitors in the second state of the 4:1 mode.

Referring to FIG. 2a, in the first state of the 4:1 mode, a first switch S1, a fourth switch S4, a fifth switch S5, a seventh switch S7, and a tenth switch S10 can be turned on, and a second switch S2, a third switch S3, a sixth switch S6, an eighth switch S8, and a ninth switch S9 can be turned off.

In this instance, as shown in FIG. 2b, a first terminal of a first capacitor C1 can be connected to an input terminal; a second terminal of the first capacitor C1 can be connected to a first terminal of a third capacitor C3; a second terminal of the third capacitor C3 can be connected to a first terminal of a second capacitor C2 and an output terminal; and a second terminal of the second capacitor C2 can be connected a reference voltage.

Referring to FIG. 2b, in the first state of the 4:1 mode, an input voltage vin, an output voltage Vo, a first capacitor voltage V1, a second capacitor voltage V2, and a third capacitor voltage V3 may have the following relationship.

vin=V1+V3+Vo (Equation 1)

V2=Vo (Equation 2)

Referring to FIG. 3a, in the second state of the 4:1 mode, a second switch S2, a third switch S3, a sixth switch S6, an eighth switch S8, and a ninth switch S9 can be turned on, and a first switch S1, a fourth switch S4, a fifth switch S5, a seventh switch S7, and a tenth switch S10 can be turned off.

In this instance, as shown in FIG. 3b, a first terminal of a first capacitor C1 can be connected to a first terminal of a second capacitor C2; a second terminal of the first capacitor C1 can be connected to a reference voltage; a second terminal of the second capacitor C2 can be connected to a first terminal of a third capacitor C3 and an output terminal; and a second terminal of the third capacitor C3 can be connected a reference voltage.

Referring to FIG. 3b, in the second state of the 4:1 mode, an input voltage vin, an output voltage Vo, a first capacitor voltage V1, a second capacitor voltage V2, and a third capacitor voltage V3 may have the following relationship.

V3=Vo (Equation 3)

V1=V2+Vo (Equation 4)

In one switching period, when the first state and the second state repeatedly performed, the capacitors (C1˜C3) reach a steady state. Assuming that a capacitance is large enough to neglect a change in a capacitor voltage in one switching period in the steady state, it is possible to analyze a relationship in the steady state of the capacitor voltages (V1˜V3), the input voltage vin, and the output voltage Vo, from Equation 1 to Equation 4.

By solving Equation 1 to Equation 4, the following relationship between voltages is derived.

V1=2Vo

V2=V3=Vo

vin=4Vo

That is, since the input voltage Vin is four times the output voltage Vo, when the switch capacitor converter 100 illustrated in FIG. 1 operates in the circuit structures illustrated in FIG. 2 or 3, it is possible to implement the voltage conversion ratio of 4:1. At this time, the first capacitor voltage V1 is two times the output voltage Vo, and each of the second capacitor voltage V2 and the third capacitor voltage V3 is equal to the output voltage Vo. Here, it should be understood that there may occur a margin of error in a voltage relationship between capacitors, and this may be equally applied to examples or embodiments discussed below.

Voltage stresses applied to capacitors and switches of the switch capacitor converter 100 operating in the voltage conversion ratio of 4:1 can be summarized as shown in Table 1 below.

TABLE 1

| C1 | C2 | C3 | S1 | S2 | S3 | S4 | S5 | S6 | S7 | S8 | S9 | S10 |
|---|---|---|---|---|---|---|---|---|---|---|---|---|
| 2Vo | Vo | Vo | 2Vo | 2Vo | 3Vo | Vo | Vo | Vo | Vo | Vo | Vo | Vo |

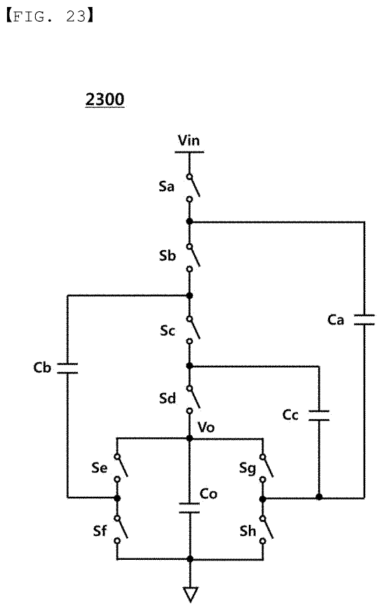

As an example for comparing with a conventional converter, a typical 4:1 Dickson converter 2300 is discussed with reference to FIG. 23. The 4:1 Dickson converter 2300 can include three capacitors (Ca, Cb, and Cc) and eight switches (Sa˜Sh).

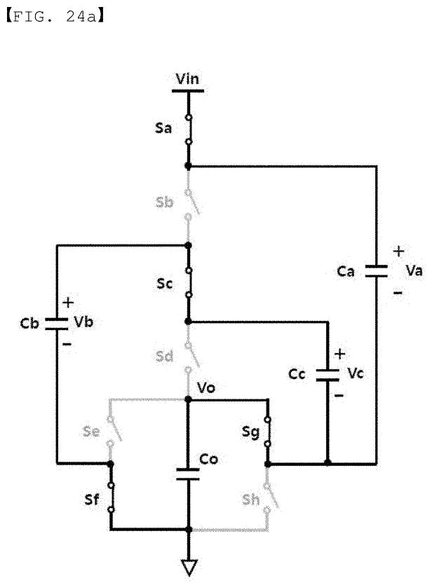

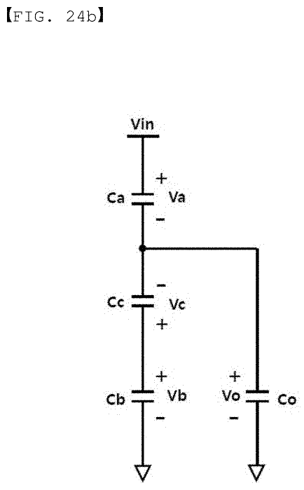

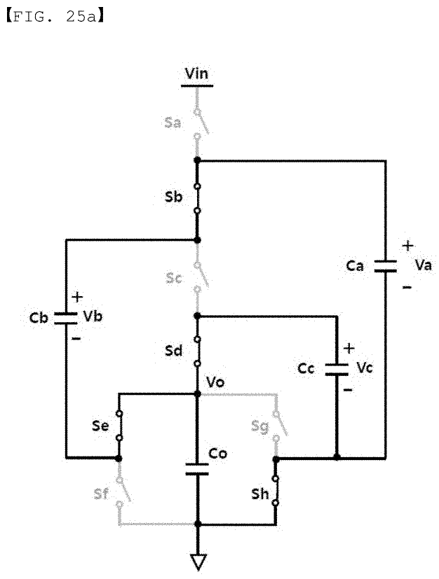

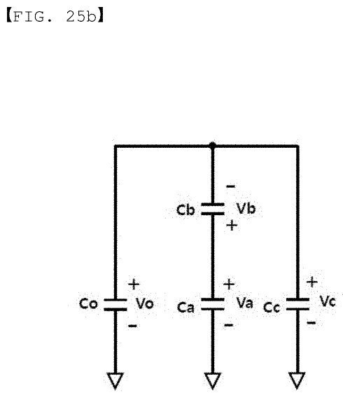

FIG. 24a illustrates a switch connection state in a first state (state 1), and FIG. 24b equivalently illustrates a connection relationship of capacitors in the first state. FIG. 25a illustrates a switch connection state in a second state (state 2), and FIG. 25b equivalently illustrates a connection relationship of capacitors in the second state.

Referring to FIG. 24a, in the first state, an a switch Sa, a c switch Sc, an f switch Sf, and a g switch Sg can be turned on, and a b switch Sb, a d switch Sd, an e switch Se, and an h switch Sh can be turned off.

In this case, the capacitors have a connection relationship as shown in FIG. 24b, and this can be expressed as the following equations.

vin=Va−Vc+Vb (Equation 5)

Vo=Vb−Vc (Equation 6)

Referring to FIG. 25a, in the second state, the b switch Sb, the d switch Sd, the e switch Se, and the h switch Sh can be turned on, and the a switch Sa, the c switch Sc, the f switch Sf, and the g switch Sg can be turned off.

In this case, the capacitors have a connection relationship as shown in FIG. 25b, and this can be expressed as the following equations.

Vo=Vc (Equation 7)

Vo=Va−Vb (Equation 8)

By solving Equation 5 to Equation 8, the following relationship between voltages is derived.

Va=3Vo

Vb=2Vo

Vc=Vo

vin=4Vo

That is, since the input voltage Vin is four times the output voltage, it is possible for the Dickson converter 2300 illustrated in FIG. 23 to implement the voltage conversion ratio of 4:1. At this time, a voltage Va of the a capacitor is three times the output voltage Vo; a voltage Vb of the b capacitor is two times the output voltage Vo; and a voltage Vc of the c capacitor is equal to the output voltage Vo.

Voltage stresses applied to capacitors and switches of the 4:1 Dickson converter 2300 can be summarized as shown in Table 2 below.

TABLE 2

| Ca | Cb | Cc | Sa | Sb | Sc | Sd | Se | Sf | Sg | Sh |
|---|---|---|---|---|---|---|---|---|---|---|
| 3Vo | 2Vo | Vo | 3Vo | 2Vo | 2Vo | Vo | Vo | Vo | Vo | Vo |

In the 4:1 Dickson converter 2300, even when the voltage of Vo is applied to the switch Sa in the steady state, considering the turn-on or turn-off of the converter, the transient state of the input voltage, or the like, a stress of about 3 times Vo is applied to the switch in an actual instance; therefore, it may be needed to use a component having a breakdown voltage of 3Vo. In the case of the switch capacitor converter 100 shown in FIG. 1, since the voltage stress of 2Vo is applied to each of the first switch S1 and the second switch S2 in the steady state, it is not necessary to employ a component with a higher breakdown voltage separately in consideration of the turn-on or turn-off of the converter and the transient state of the input voltage.

Table 3 below shows results of comparing a voltage stress of components of the switch capacitor converter 100 operating in the voltage conversion ratio of 4:1 according to the embodiment illustrated in FIG. 1 to a corresponding voltage stress of components of the typical 4:1 Dickson capacitor 2300 illustrated in FIG. 23.

TABLE 3

| | Voltage | Converter 100 | 4:1 Dickson |
|---|---|---|---|
| | stress | of FIG. 1 | converter 2300 |
| Capacitor | Vo | 2 capacitors | 1 capacitor |
| | 2Vo | 1 capacitor | 1 capacitor |
| | 3Vo | — | 1 capacitor |
| Switch | Vo | 7 switches | 5 switches |
| | 2Vo | 2 switches | 2 switches |
| | 3Vo | 1 switch | 1 switch |

As compared through Table 3, in the switch capacitor converter 100 according the embodiment illustrated in FIG. 1, although two additional switches with a lower voltage stress Vo are required as compared to the 4:1 Dickson converter 2300, it is possible to employ a capacitor with the breakdown voltage of Vo, instead of a capacitor with the breakdown voltage of 3Vo. As described above, since the breakdown voltage of the capacitor greatly affects efficiency and a size of the switch capacitor converter, the switch capacitor converter 100 according the embodiment illustrated in FIG. 1 has a reduced size and improved efficiency as compared to the 4:1 Dickson converter 2300.

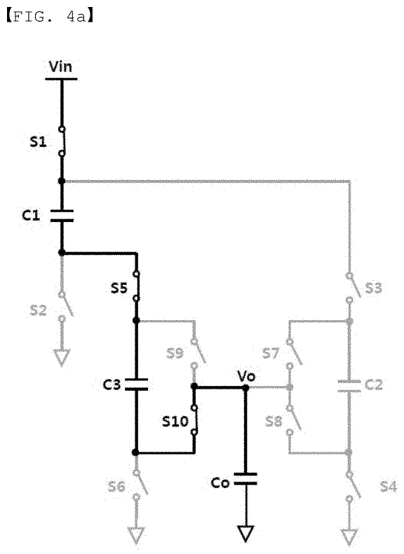

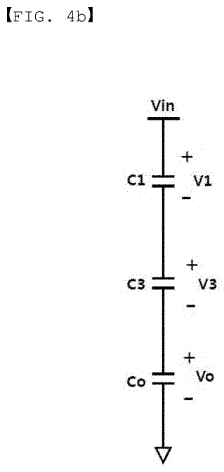

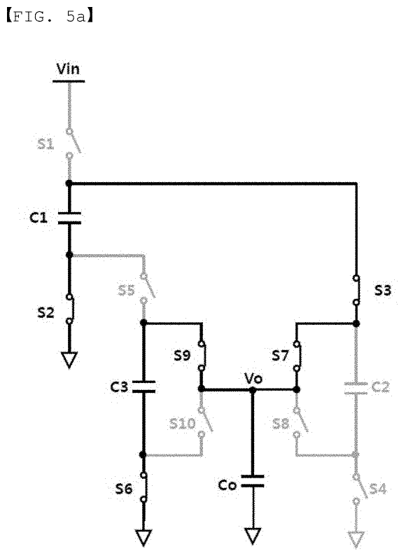

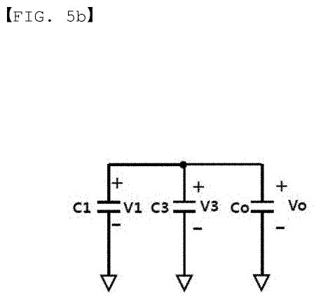

FIGS. 4 and 5 illustrate that the switch capacitor converter 100 illustrated in FIG. 1 operates in a 3:1 voltage conversion.

FIG. 4a illustrates a switch connection state in a first state (state 1) of the 3:1 mode, and FIG. 4b equivalently illustrates a connection relationship of capacitors in the first state of the 3:1 mode. FIG. 5a illustrates a switch connection state in a second state (state 2) of the 3:1 mode, and FIG. 5b equivalently illustrates a connection relationship of capacitors in the second state of the 3:1 mode.

Referring to FIG. 4a, in the first state of the 3:1 mode, a first switch S1, a fifth switch S5, and a tenth switch S10 can be turned on, and a second switch S2, a third switch S3, a fourth switch S4, a sixth switch S6, a seventh switch S7, an eighth switch S8, and a ninth switch S9 can be turned off.

In this instance, as shown in FIG. 4b, a first terminal of the first capacitor C1 can be connected to an input terminal; a second terminal of the first capacitor C1 can be connected to a first terminal of the third capacitor C3; and a second terminal of the third capacitor C3 can be connected to an output terminal.

Referring to FIG. 4b, in the first state of the 3:1 mode, an input voltage vin, an output voltage Vo, a first capacitor voltage V1, a second capacitor voltage V2, and a third capacitor voltage V3 may have the following relationship.

vin=V1+V3+Vo (Equation 9)

Referring to FIG. 5a, in the second state of the 3:1 mode, a second switch S2, a third switch S3, a sixth switch S6, a seventh switch S7, and a ninth switch S9 can be turned on, and a first switch S1, a fourth switch S4, a fifth switch S5, an eighth switch S8, and a tenth switch S10 can be turned off.

In this instance, as shown in FIG. 5b, a first terminal of the first capacitor C1 and a first terminal of the third capacitor C3 can be connected to an output terminal; and a second terminal of the first capacitor C1 and a second terminal of the third capacitor C3 can be connected to a reference voltage.

Referring to FIG. 5b, in the second state of the 3:1 mode, an input voltage vin, an output voltage Vo, a first capacitor voltage V1, and a third capacitor voltage V3 may have the following relationship.

V1=V3=Vo (Equation 10)

By solving Equation 9 and Equation 10, the following relationship between voltages is derived.

V1=V3=Vo

Vin=3Vo

That is, since the input voltage Vin is three times the output voltage Vo, when the switch capacitor converter 100 illustrated in FIG. 1 operates in the circuit structures illustrated in FIG. 4 or 5, it is possible to implement the voltage conversion ratio of 3:1. At this time, each of the first capacitor voltage V1 and the third capacitor voltage V3 is equal to the output voltage Vo.

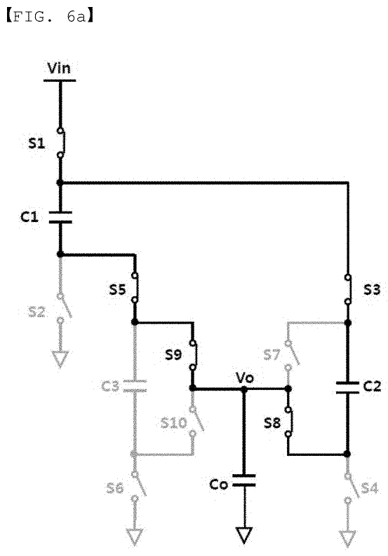

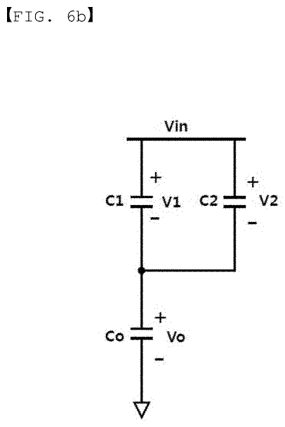

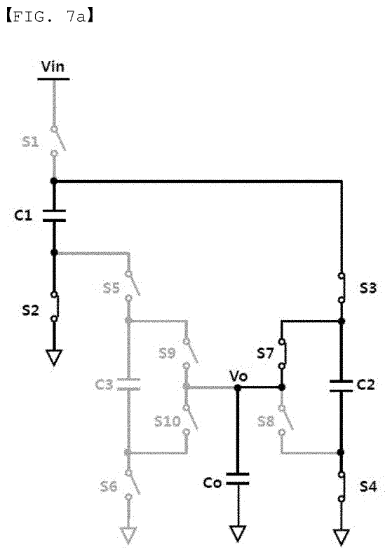

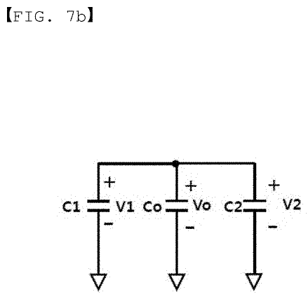

FIGS. 6 and 7 illustrate that the switch capacitor converter 100 illustrated in FIG. 1 operates in a 2:1 voltage conversion.

FIG. 6a illustrates a switch connection state in a first state (state 1) of the 2:1 mode, and FIG. 6b equivalently illustrates a connection relationship of capacitors in the first state of the 2:1 mode. FIG. 7a illustrates a switch connection state in a second state (state 2) of the 2:1 mode, and FIG. 7b equivalently illustrates a connection relationship of capacitors in the second state of the 2:1 mode.

Referring to FIG. 6a, in the first state of the 2:1 mode, a first switch S1, a third switch S3, a fifth switch S5, an eighth switch S8, and a ninth switch S9 can be turned on, and a second switch S2, a fourth switch S4, a sixth switch S6, a seventh switch S7, and a tenth switch S10 can be turned off.

In this instance, as shown in FIG. 6b, a first terminal of the first capacitor C1 and a first terminal of the second capacitor C2 can be connected to an input terminal; and a second terminal of the first capacitor C1 and a second terminal of the second capacitor C2 can be connected to an output terminal.

Referring to FIG. 6b, in the first state of the 2:1 mode, an input voltage vin, an output voltage Vo, a first capacitor voltage V1, and a second capacitor voltage V2 may have the following relationship.

Vin=V1+Vo (Equation 11)

V1=V2 (Equation 12)

Referring to FIG. 7a, in the second state of the 2:1 mode, a second switch S2, a third switch S3, a fourth switch S4, and a seventh switch S7 can be turned on, and a first switch S1, a fifth switch S5, a sixth switch S6, an eighth switch S8, a ninth switch S9 and a tenth switch S10 can be turned off.

In this instance, as shown in FIG. 7b, a first terminal of the first capacitor C1 and a first terminal of the second capacitor C2 can be connected to an output terminal; and a second terminal of the first capacitor C1 and a second terminal of the second capacitor C2 can be connected to a reference voltage.

Referring to FIG. 7b, in the second state of the 2:1 mode, an input voltage vin, an output voltage Vo, a first capacitor voltage V1, and a second capacitor voltage V2 may have the following relationship.

V1=V2=Vo (Equation 13):

By solving Equation 11 to Equation 13, the following relationship between voltages is derived.

V1=V2=Vo

Vin=2Vo

That is, since the input voltage Vin is two times the output voltage Vo, when the switch capacitor converter 100 illustrated in FIG. 1 operates in the circuit structures illustrated in FIG. 6 or 7, it is possible to implement the voltage conversion ratio of 2:1. At this time, each of the first capacitor voltage V1 and the second capacitor voltage V2 is equal to the output voltage Vo.

Thus, without employing a capacitor with a high breakdown voltage, the switch capacitor converter 100 illustrated in FIG. 1 can operate with high efficiency in a reduced size and, and operate in a voltage conversion ratio selected from 4:1, 3:1 and 2:1 when needed.

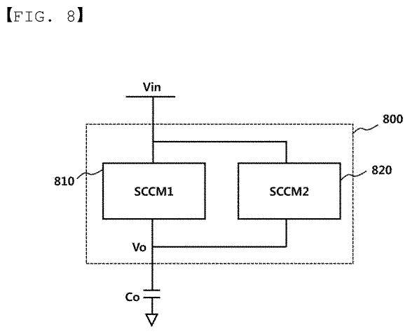

FIG. 8 is a diagram illustrating a switch capacitor converter 800 using two switch capacitor converter modules 810 and 820 in parallel according to embodiments of the present disclosure.

The switch capacitor converter 800 can receive an input voltage Vin through an input terminal and supply an output voltage Vo through an output terminal.

A switch capacitor converter module 810 can receive the input voltage Vin through the input terminal and supply the output voltage Vo through the output terminal.

A second switch capacitor converter module 820 can include at least one switch and at least one capacitor, and share the input terminal and the output terminal with the first switch capacitor converter module 801.

That is, the first switch capacitor converter module 810 and the second switch capacitor converter module 820 can be connected in parallel with each other, and share the input voltage Vin and the output voltage Vo.

In some embodiments, the first switch capacitor converter module 810 and the second switch capacitor converter module 820 can include a circuit identical to each other.

In some embodiments, the first switch capacitor converter module 810 and the second switch capacitor converter module 820 can operate in a manner interleaved with each other (hereinafter, referred to as “interleaved manner”) Here, the interleaved manner means that in a case where each of the first switch capacitor converter module 810 and the second switch capacitor converter module 820 repeats a first state and a second state in a switching period as discussed with reference to FIGS. 2 to 7, when the first switch capacitor converter module 810 operates in the first state, the second switch capacitor converter module 820 operates in the second state, and when the first switch capacitor converter module 810 operates in the second state, the second switch capacitor converter module 820 operates in the first state. When the first switch capacitor converter 810 and the second switch capacitor converter module 820 operate in the interleaved manner, it is possible to reduce ripples in an input voltage or current, or ripples in an output voltage or current. Further, as described below, the interleaved manner has an advantage of reducing the number of components and a size of the converter by integrating or sharing at least one capacitor and/or at least one switch between the first switch capacitor converter module 810 and the second switch capacitor converter module 820.

Thus, the switch capacitor converter 800 in which two switch capacitor converter module 810 and 820 operate in the interleaved manner with each other may be referred to as being configured in a two-phase.

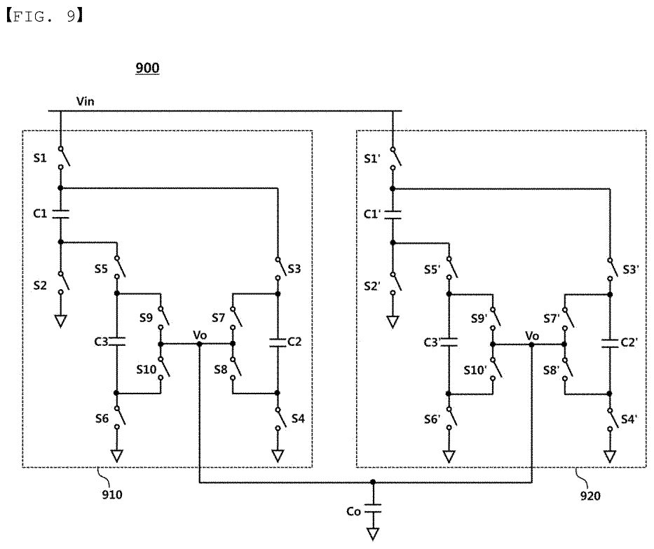

As one embodiment, FIG. 9 illustrates a switch capacitor converter 900 in which the switch capacitor converter 100 illustrated in FIG. 1 is employed in each of the switch capacitor converter modules 810 and 820 illustrated in FIG. 8.

Respective circuits of the first and second switch capacitor converter modules 910 and 920 are substantially equal to description given with reference to FIG. 1; therefore, related description is not conducted repeatedly.

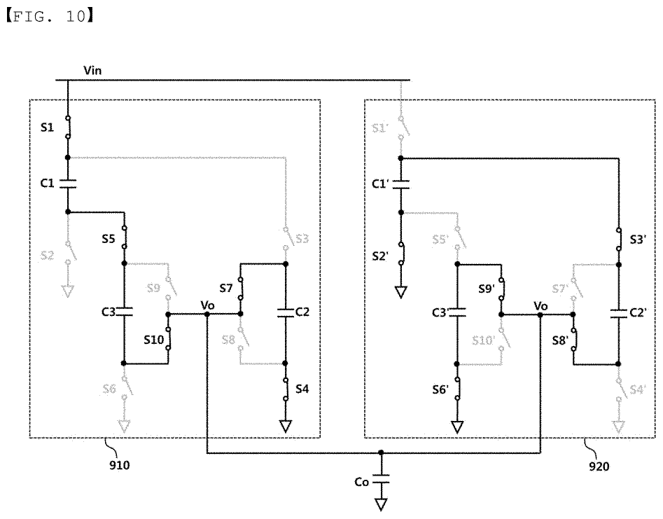

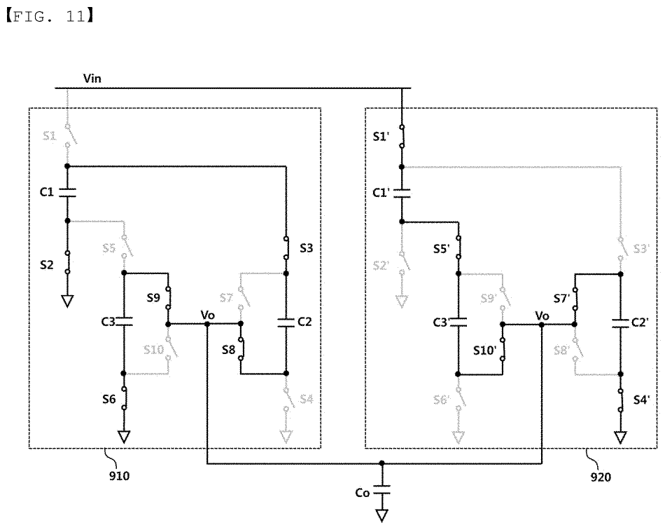

FIGS. 10 and 11 illustrate that the switch capacitor converter 900 illustrated in FIG. 9 operates in a 4:1 voltage conversion.

Referring to FIG. 10, in an a state of the 4:1 mode, the switch capacitor converter 900 operates such that the first switch capacitor converter module 910 can operate in a first state (referring to FIG. 2) of the 4:1 mode, and the second switch capacitor converter module 920 can operate in a second state (referring to FIG. 3) of the 4:1 mode.

For example, in the case of the first switch capacitor converter module 910, a first switch S1, a fourth switch S4, a fifth switch S5, a seventh switch S7, and a tenth switch S10 can be turned on, and a second switch S2, a third switch S3, a sixth switch S6, an eighth switch S8, and a ninth switch S9 can be turned off. In the case of the second switch capacitor converter module 920, a second switch S2′, a third switch S3′, a sixth switch S6′, an eighth switch S8′, and a ninth switch S9′ can be turned on, and a first switch S1′, a fourth switch S4′, a fifth switch S5′, a seventh switch S7′, and a tenth switch S10′ can be turned off. The description given with reference to FIGS. 2 and 3 may be equally applicable to a specific operation in the first state and the second state in the switch capacitor converter illustrated in FIG. 10.

Referring to FIG. 11, in an b state of the 4:1 mode, the switch capacitor converter 900 operates such that the first switch capacitor converter module 910 can operate in the second state (referring to FIG. 3) of the 4:1 mode, and the second switch capacitor converter module 920 can operate in the first state (referring to FIG. 2) of the 4:1 mode.

For example, in the case of the first switch capacitor converter module 910, a second switch S2, a third switch S3, a sixth switch S6, an eighth switch S8, and a ninth switch S9 can be turned on, and a first switch S1, a fourth switch S4, a fifth switch S5, a seventh switch S7, and a tenth switch S10 can be turned off. In the case of the second switch capacitor converter module 920, a first switch S1′, a fourth switch S4′, a fifth switch S5′, a seventh switch S7′, and a tenth switch S10′ can be turned on, and a second switch S2′, a third switch S3′, a sixth switch S6′, an eighth switch S8′, and a ninth switch S9′ can be turned off. Likewise, the description given with reference to FIGS. 2 and 3 may be equally applicable to a specific operation in the first state and the second state in the switch capacitor converter illustrated in FIG. 11.

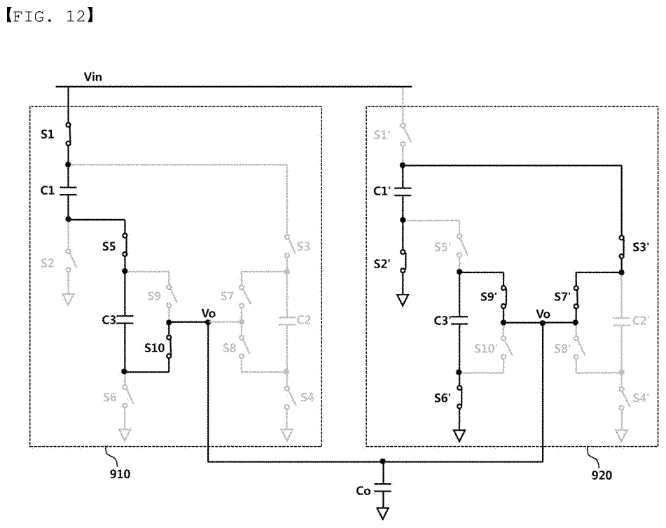

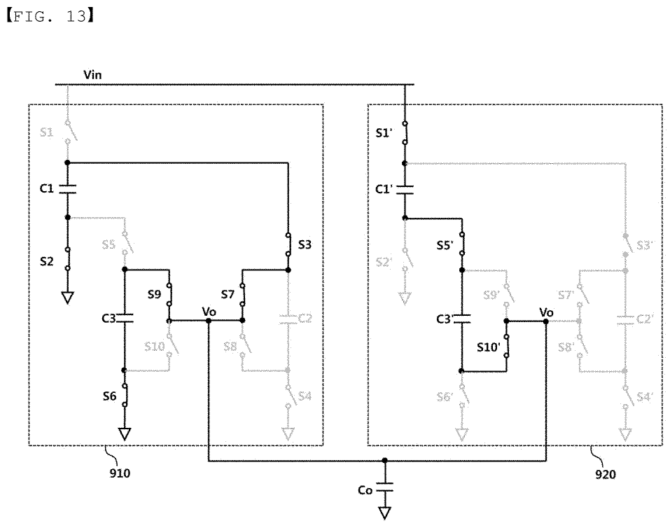

FIGS. 12 and 13 illustrate a 3:1 voltage conversion operation of the switch capacitor converter illustrated in FIG. 9.

Referring to FIG. 12, in an a state of the 3:1 mode, the switch capacitor converter 900 operates such that the first switch capacitor converter module 910 can operate in a first state (referring to FIG. 4) of the 3:1 mode, and the second switch capacitor converter module 920 can operate in a second state (referring to FIG. 5) of the 3:1 mode.

For example, in the case of the first switch capacitor converter module 910, a first switch S1, a fifth switch S5, and a tenth switch S10 can be turned on, and a second switch S2, a third switch S3, a fourth switch S4, a sixth switch S6, a seventh switch S7, an eighth switch S8, and a ninth switch S9 can be turned off. In the case of the second switch capacitor converter module 920, a second switch S2′, a third switch S3′, a sixth switch S6′, a seventh switch S7′, and a ninth switch S9′ can be turned on, and a first switch S1′, a fourth switch S4′, a fifth switch S5′, an eighth switch S8′, and a tenth switch S10′ can be turned off. The description given with reference to FIGS. 4 and 5 may be equally applicable to a specific operation in the first state and the second state in the switch capacitor converter illustrated in FIG. 12.

Referring to FIG. 13, in a b state of the 3:1 mode, the switch capacitor converter 900 operates such that the first switch capacitor converter module 910 can operate in the second state (referring to FIG. 5) of the 3:1 mode, and the second switch capacitor converter module 920 can operate in the first state (referring to FIG. 4) of the 3:1 mode.

For example, in the case of the first switch capacitor converter module 910, a second switch S2, a third switch S3, a sixth switch S6, a seventh switch S7, and a ninth switch S9 can be turned on, and a first switch S1, a fourth switch S4, a fifth switch S5, an eighth switch S8, and a tenth switch S10 can be turned off. In the case of the second switch capacitor converter module 920, a first switch S1′, a fifth switch S5′, and a tenth switch S10′ can be turned on, and a second switch S2′, a third switch S3′, a fourth switch S4′, a sixth switch S6′, a seventh switch S7′, an eighth switch S8′, and a ninth switch S9′ can be turned off. Likewise, the description given with reference to FIGS. 4 and 5 may be equally applicable to a specific operation in the first state and the second state in the switch capacitor converter illustrated in FIG. 13.

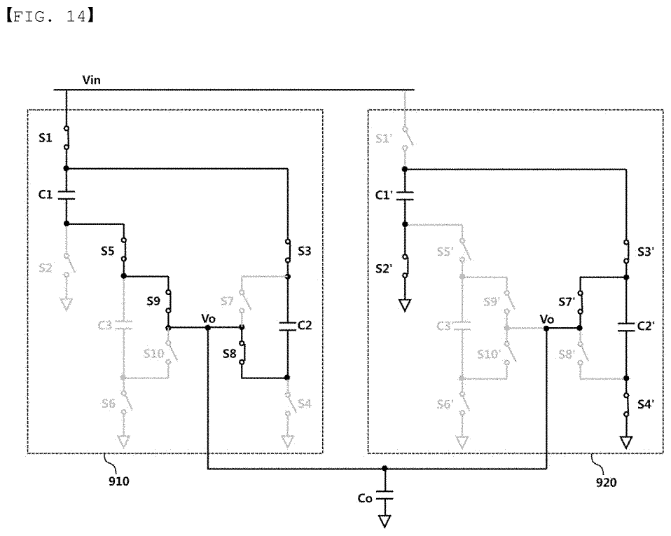

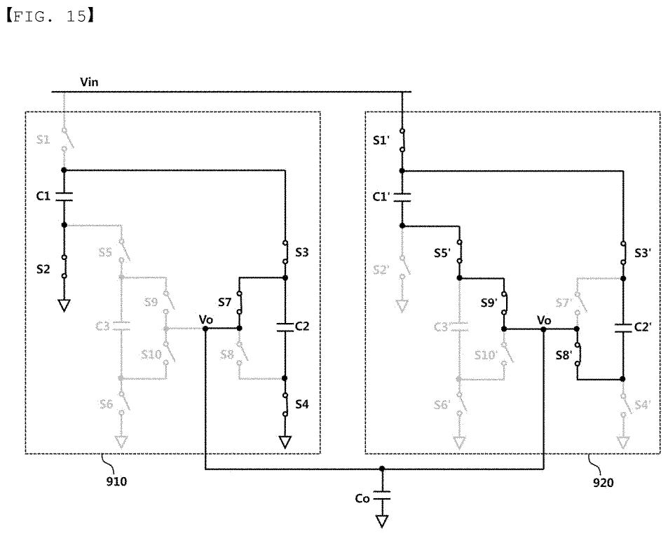

FIGS. 14 and 15 illustrate a 2:1 voltage conversion operation of the switch capacitor converter illustrated in FIG. 9.

Referring to FIG. 14, in an a state of the 2:1 mode, the switch capacitor converter 900 operates such that the first switch capacitor converter module 910 can operate in a first state (referring to FIG. 6) of the 2:1 mode, and the second switch capacitor converter module 920 can operate in a second state (referring to FIG. 7) of the 2:1 mode.

For example, in the case of the first switch capacitor converter module 910, a first switch S1, a third switch S3, a fifth switch S5, an eighth switch S8, and a ninth switch S9 can be turned on, and a second switch S2, a fourth switch S4, a sixth switch S6, a seventh switch S7, and a tenth switch S10 can be turned off. In the case of the second switch capacitor converter module 920, a second switch S2′, a third switch S3′, a fourth switch S4′, and a seventh switch S7′ can be turned on, and a first switch S1′, a fifth switch S5′, a sixth switch S6′, an eighth switch S8′, a ninth switch S9′, and a tenth switch S10′ can be turned off. The description given with reference to FIGS. 6 and 7 may be equally applicable to a specific operation in the first state and the second state in the switch capacitor converter illustrated in FIG. 14.

Referring to FIG. 15, in a b state of the 2:1 mode, the switch capacitor converter 900 operates such that the first switch capacitor converter module 910 can operate in the second state (referring to FIG. 7) of the 2:1 mode, and the second switch capacitor converter module 920 can operate in the first state (referring to FIG. 6) of the 2:1 mode.

For example, in the case of the first switch capacitor converter module 910, a second switch S2, a third switch S3, a fourth switch S4, and a seventh switch S7 can be turned on, and a first switch S1, a fifth switch S5, a sixth switch S6, an eighth switch S8, a ninth switch S9, and a tenth switch S10 can be turned off. In the case of the second switch capacitor converter module 920, a first switch S1′, a third switch S3′, a fifth switch S5′, an eighth switch S8′, and a ninth switch S9′ can be turned on, and a second switch S2′, a fourth switch S4′, a sixth switch S6′, a seventh switch S7′, and a tenth switch S10′ can be turned off. Likewise, the description given with reference to FIGS. 6 and 7 may be equally applicable to a specific operation in the first state and the second state in the switch capacitor converter illustrated in FIG. 14.

Referring to FIGS. 10 to 15, it is possible for the two-phase switch capacitor converter 900 to implement selectively the voltage conversion ratio as one of 4:1, 3:1 or 2:1. Further, even when the switch capacitor converter 900 implements the voltage conversion ratio as any of 4:1, 3:1 or 2:1, an interleaving operation can be implemented because the a state and the b state are alternately performed within a switching period, and the first switch capacitor converter 910 and the second switch capacitor converter 920 operate such that the first switch capacitor converter 910 and the second switch capacitor converter 920 are inverted relative to each other in each of the a state and the b state. Accordingly, ripples of the voltages or currents in the input and output terminals may reduce, and thus, the switch capacitor converter 900 can operate more efficiently.

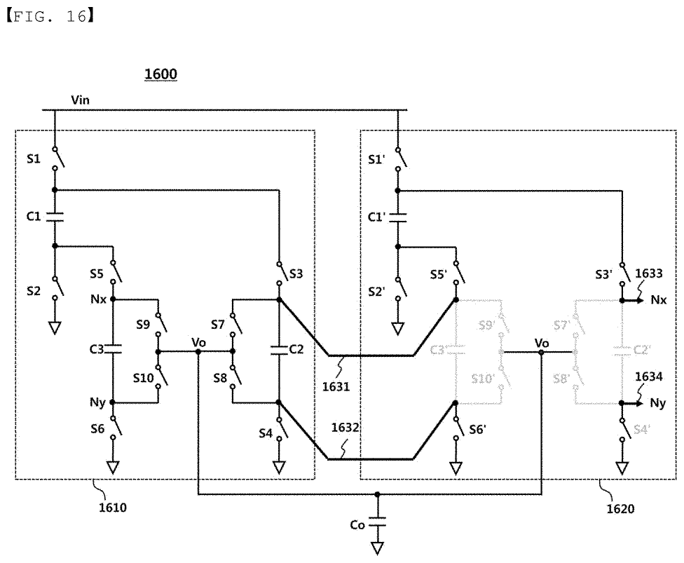

As one embodiment, FIG. 16 illustrates a switch capacitor converter 1600 that integrates or shares at least one capacitor and/or at least one switch of the switch capacitor converter modules 910 and 920 illustrated in FIG. 9.

When the switch capacitor converter 900 illustrated in FIG. 9 operates in a voltage conversion ratio of 4:1 or 2:1, the second capacitor C2 of the first switch capacitor converter module 910 and the third capacitor C3′ of the second switch capacitor converter module 920 maintain an identical voltage to each other in both the a state and the b state (see FIGS. 10 and 11 and FIGS. 14 and 15). When the switch capacitor converter 900 operates in a voltage conversion ratio of 4:1 or 2:1, the second capacitor C3 of the first switch capacitor converter module 910 and the second capacitor C2′ of the second switch capacitor converter module 920 maintain an identical voltage to each other in both the a state and the b state (see FIGS. 10 and 11 and FIGS. 14 and 15).

Accordingly, as illustrated in FIG. 16, according to embodiments of the present disclosure, lines 1631 and 1632 can be added to connect a second capacitor C2 of a first switch capacitor converter module 1610 and a third capacitor C3′ of a second switch capacitor converter module 1620 in parallel with each other. In this case, since the two capacitors C2 and C3′ are used by being integrated into one, it is possible to reduce the number of capacitors, or to increase the effective capacitance of the capacitors, while having small capacitances, by sharing the capacitors C2 and C3′ even when the capacitors C2 and C3′ are used in respective switch capacitor converter modules 1610 and 1620. Herein, it can be understood that the integrating or sharing of one or more capacitors includes all of the above two instances.

Further, according to embodiments of the present disclosure, lines 1633 and 1634 can be added to connect the second capacitor C3 of the first switch capacitor converter module 1610 and the second capacitor C2′ of the second switch capacitor converter module 1620 in parallel with each other. Likewise, by integrating the two capacitors C2 and C3, it is possible to reduce the number of capacitors, or to increase the effective capacitance of the capacitors.

Meanwhile, when the lines 1631 and 1632 connecting the two capacitors C2 and C3′ and the lines 1633 and 1634 connecting the two capacitors C3 and C2′ in parallel are used, a structure is established in which switches included in each of six pairs of switches (S4 and S6′, S6 and S4′, S7 and S9′, S8 and S10′, S9 and S7′, and S10 and S8) are connected in parallel with each other.

When the switch capacitor converter 1600 operates in a voltage conversion ratio of 4:1 or 2:1, since each of the six pairs of switches (S4 and S6′, S6 and S4′, S7 and S9′, S8 and S10′, S9 and S7′, and S10 and S8′) has an identical on/off state in both an a state and a b state, there is no problem for enabling the switch capacitor converter 1600 to operate (see FIGS. 10 and 11 and FIGS. 14 and 15). Although FIG. 14 or 15 illustrates the switch capacitor converter operating in the voltage conversion ratio of 2:1 such that each of two switches in each of a pair of the S8 and the S10′ and a pair of the S6 and the S4′ of FIG. 14, or each of two switches in each of a pair of the S4 and the S6′ and a pair of the S10 and the S8′ of FIG. 15, has an on/off state different from each other, it should be noted that it is possible to change an on/off state of one of the two switches to have an identical state to each other. For example, although FIG. 14 illustrates that S8 is in an on state and S10′ is in an off state, the changing of S10′ into the on state does not affect the operation of the switch capacitor converter.

FIG. 16 illustrates an instance where S7′, S8′, S9′, and S10′ are removed from the second switch capacitor converter module 1620 (shown in a light color) by sharing four pairs (S7 and S9′, S8 and S10′, S9 and S7′, and S10 and S8′) of the sixth pairs of switches.

Thus, the switch capacitor converter 1600 illustrated in FIG. 16 can significantly reduce the number of components, while operating two modules 1610 and 1620 in the interleaved manner. Table 4 below shows results of comparing the number and voltage stresses of components between an instance where the switch capacitor converter 1600 illustrated in FIG. 16 is operated in the voltage conversion ratio of 4:1 and an instance where two modules each including the 4:1 Dickson converter 2300 illustrated in FIG. 23 are used in parallel. Although the number of switches or the voltage stress is equal in two instances, the switch capacitor converter 1600 has a significant advantage without employing two capacitors with a high breakdown voltage (3Vo) as compared to the instance where two modules each including the 4:1 Dickson converter 2300 are used.

TABLE 4

| | | | 4:1 Dickson |
|---|---|---|---|
| | Voltage | Converter 1600 | converter 2300 |
| | stress | of FIG. 16 | (Using two modules) |
| Capacitor | Vo | 2 capacitors | 2 capacitors |
| | 2Vo | 2 capacitors | 2 capacitors |
| | 3Vo | — | 2 capacitors |
| Switch | Vo | 10 switches | 10 switches |
| | 2Vo | 4 switches | 4 switches |
| | 3Vo | 2 switches | 2 switches |

Thus, it is possible to integrate C2 and C3′, S4 and S6′, S7 and S9′, or S8 and S10′ by adding lines 1631 and 1632 between the first switch capacitor converter module 1610 and the second switch capacitor converter module 1620, and it is possible to integrate C3 and C2′, S6 and S4′, S9 and S7′, or S10 and S8′ by adding lines 1633 and 1634 between the first switch capacitor converter module 1610 and the second switch capacitor converter module 1620. A pair to be integrated among the above two capacitor pairs and the above six switch pairs may be appropriately selected according to a situation or a requirement.

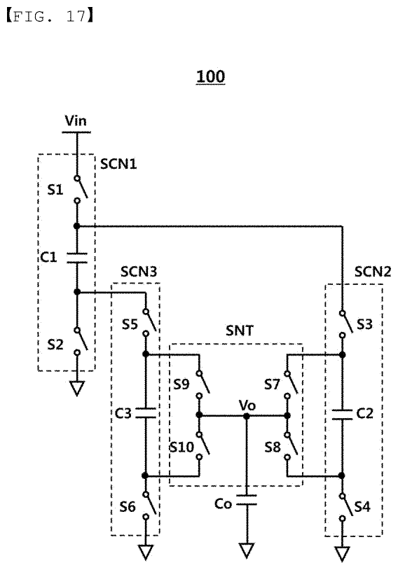

FIG. 17 illustrates that the switch capacitor converter 100 illustrated in FIG. 1 is divided into several networks.

Referring to FIG. 17, it can be understood that the switch capacitor converter 100 includes three switch capacitor networks SCN1, SCN2 and SCN3 and one output switch network SNT.

The first switch capacitor network SCN1 can be understood as a network in which i) a first switch S1, a first capacitor C1, and a second switch S2 are connected in series, ii) a first terminal of the first switch S1 is connected to an input terminal, and iii) a second terminal of the second switch S2 is connected to a reference voltage.

The second switch capacitor network SCN2 can be understood as a network in which i) a third switch S3, a second capacitor C2, and a fourth switch S4 are connected in series, ii) a first terminal of the third switch S3 is connected to a first terminal of the first capacitor C1, and iii) a second terminal of the fourth switch S4 is connected to the reference voltage.

The third switch capacitor network SCN3 can be understood as a network in which i) a fifth switch S5, a third capacitor S3, and a sixth switch S6 are connected in series, ii) a first terminal of the fifth switch S5 is connected to a second terminal of the first capacitor C1, and iii) a second terminal of the sixth switch S6 is connected to the reference voltage.

The output switch network SNT can be understood as a network in which a seventh switch S7 and an eighth switch S8 are connected in series and a ninth switch S9 and a tenth switch S10 are connected in series, and i) a first terminal of the seventh switch S7 and a second terminal of the eighth switch S8 are connected to both terminals of the second capacitor C2 respectively, ii) a first terminal of the ninth switch S9 and a second terminal of the tenth switch S10 are connected to both terminals of the third capacitor C3 respectively, and iii) a connection point of the seventh switch S7 and the eighth switch S8 and a connection point of the ninth switch S9 and the tenth switch S10 are connected together to an output terminal.

As described above, the upper and lower terminals in drawings which are two terminals of the switches or capacitors are referred to as the first and second terminals, respectively.

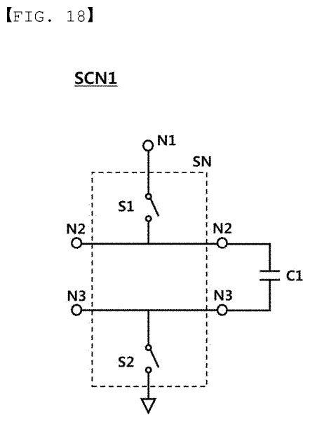

Each of three switch capacitor networks SCN1, SCN2 and SCN3 includes a structure in which two switches and one capacitor connected between the two switches are included. As such, a structure in which three switch capacitor networks SCN1, SCN2 and SCN3 having the same structure as one another are included can be represented as in FIG. 18.

Referring to FIG. 18, the first switch capacitor network SCN1 can be represented as a combination of a base switch network SN including two switches S1 and S2 and a capacitor C1.

Here, it can be understood that the base switch network SN includes a first switch S1 connected between a first node N1 and a second node N2, and a second switch S2 connected between a third node N3 and a reference voltage, and the capacitor C1 is connected between the second node N2 and the third node N3 in the outside of the base switch network SN.

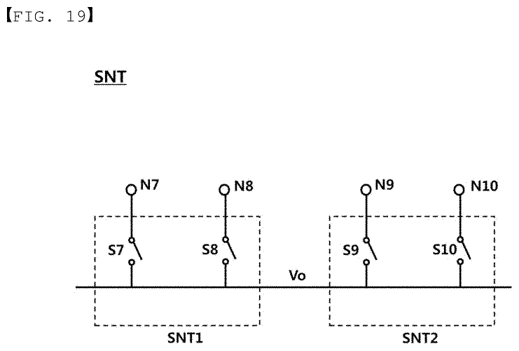

FIG. 19 illustrates an example of being reconfigured from the output switch network SNT of FIG. 17.

Referring to FIG. 19, it can be understood that the output switch network SNT includes four switches S7, S8, S9 and S10, and first and second terminals of each of the four switches S7, S8, S9 and S10 are connected to the outside and an output terminal, respectively. Here, the output switch network SNT can be understood as including a first output switch network module SNT1 including two switches S7 and S8 and a second output switch network module SNT2 including two switch network S9 and S10.

Thus, the switch capacitor converter 100 illustrated in FIG. 17 can be understood as a configuration in which unit switch networks each including two switches, and capacitors are connected to one another. Here, the unit switch network can be represented as a structure in which the base switch network SN illustrated in FIG. 18 and the output switch network modules SNT1 and SNT2 illustrated in FIG. 19 are included.

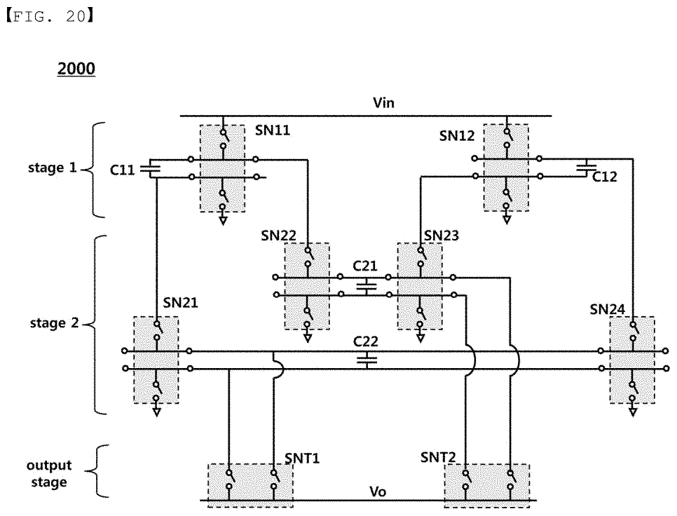

FIG. 20 illustrates a 2²:1 switch capacitor converter 2000 according to embodiments of the present disclosure. The switch capacitor converter 2000 is a structure similar to the switch capacitor converter 1600 in which two capacitors and four switches are removed by integrating or sharing capacitors and switches in two switch capacitor converter modules 1610 and 1620 (see FIG. 16). It should be noted that the switch capacitor converter 2000 has a structure resulted from reconfiguring the switch capacitor converter 1600 illustrated in FIG. 16 by using the base switch network SN and the output switch network modules SNT1 and SNT2 illustrated in each of FIGS. 18 and 19.

Referring to FIG. 20, the switch capacitor converter 2000 can be understood as including two stages (stage 1 and stage 2) and an output stage (output stage).

Two base switch networks SN11 and SN12 and two capacitors C11 and C12 can be configured in the first stage (stage 1). The capacitor C11 can be connected to the base switch network SN11, and the capacitor C12 can be connected to the base switch network SN12.

Four base switch networks SN21, SN22, SN23 and SN24 and two capacitors C21 and C22 can be configured in the second stage (stage 2). The capacitor C22 can be commonly connected to both the base switch network SN21 and the base switch network SN24, and the capacitor C21 can be commonly connected to both the base switch network SN22 and the base switch network SN23.

Each of the four base switch networks SN21, SN22, SN23 and SN24 configured in the second stage (stage 2) can be independently connected to one terminal of the two capacitors C11 and C12 in the first stage (stage 1) that is the previous stage so that at least two of the four base switch networks cannot be commonly connected to one terminal of the two capacitors C11 and C12.

Two output switch network modules SNT1 and SNT2 can be configured in the output stage (output stage). A first terminal of each of two switches of the output switch network module SNT1 can be connected to both terminals of the capacitor C22. A first terminal of each of two switches of the output switch network module SNT2 can be connected to both terminals of the capacitor C21. A second terminal of each of two switches of the output switch network module SNT1 and a second terminal of each of two switches of the output switch network module SNT2 can be commonly connected to an output terminal.

The switch capacitor converter 2000 illustrated in FIG. 20 can be implemented in the voltage conversion ratio of 4:1 by operating in a similar manner to the operation discussed with reference to FIGS. 10 and 11. Further, integrating or sharing capacitors and switches of two modules can result in a size of the switch capacitor converter 2000 being reduced, and using the interleaving manner can allow ripples of voltages or currents that are input or output to be reduced.

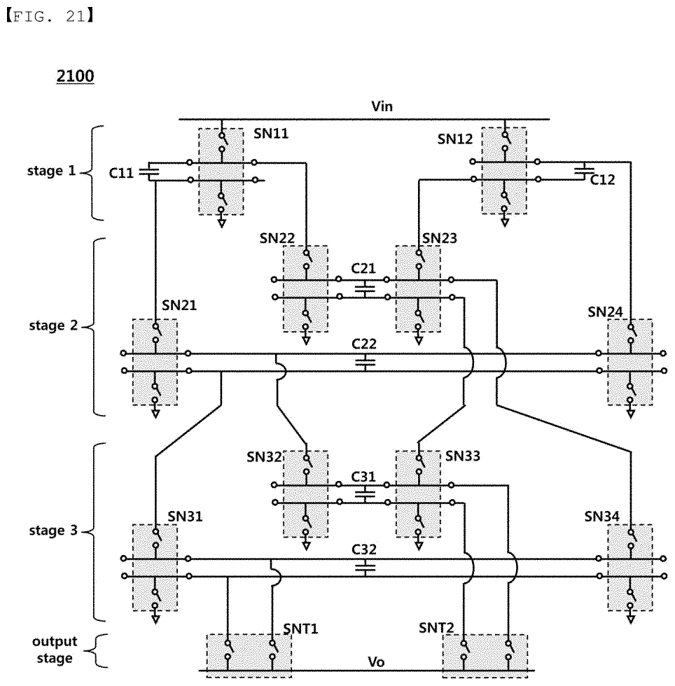

FIG. 21 illustrates a 2³:1 switch capacitor converter 2100 according to embodiments of the present disclosure. The switch capacitor converter 2100 illustrated in FIG. 21 can be implemented in the voltage conversion ratio of 2³:1 by extending the 221 switch capacitor converter 2000 illustrated in FIG. 20. To do this, a third stage (stage 3) can be further configured in the switch capacitor converter 2100 as compared with the switch capacitor converter 2000.

The third stage (stage 3) can be configured in a similar manner to the second stage. Each of the four base switch networks SN31, SN32, SN33 and SN34 configured in the third stage (stage 3) can be independently connected to one terminal of the two capacitors C21 and C22 in the second stage (stage 2) that is the previous stage so that at least two of the four base switch networks cannot be commonly connected to one terminal of the two capacitors C11 and C12.

Further, integrating or sharing capacitors and switches of two switch capacitor converter modules can result in a size of the switch capacitor converter 2100 being reduced, and using the interleaving manner can allow ripples of voltages or currents that are input or output to be reduced.

From FIGS. 20 and 21, it can be inferred that a switch capacitor converter can be implemented in which the voltage conversion ratio increases to a binary type as an intermediate stage is added.

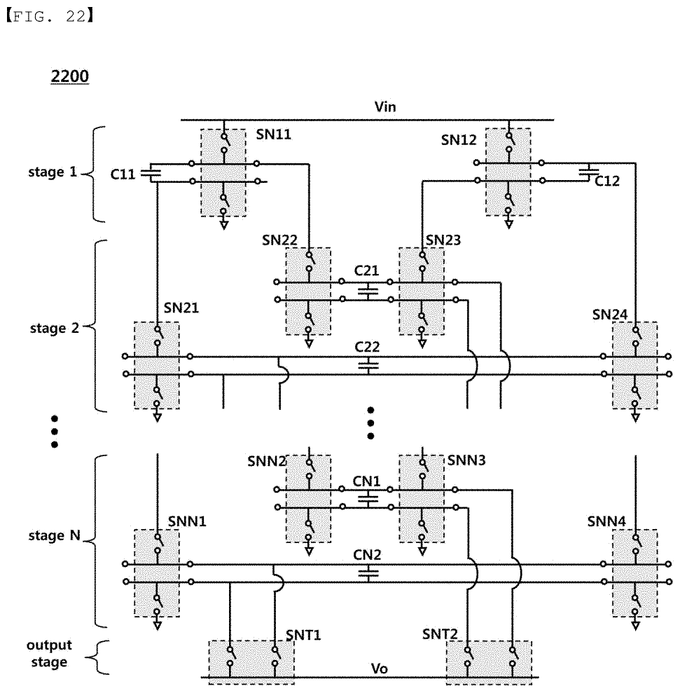

FIG. 22 illustrates a 2^{N}:1 switch capacitor converter 2200 according to embodiments of the present disclosure. That is, the switch capacitor converter 2200 of FIG. 22 illustrates a structure obtained by further expanding FIGS. 20 and 21 and then generalizing the extended structure.

The switch capacitor converter 2200 can include an N number of stages (stage 1˜stage N) and an output stage (output stage), and be configured to operate in a 2^{N}:1 ratio of an input voltage to an output voltage.

Two base switch networks SN11 and SN12 and two capacitors C11 and C12 can be configured in the first stage (stage 1).

Four base switch networks (SN21, SN22, SN23, SN24, . . . , SNN1, SNN2, SNN3, SNN4) and two capacitors (C21, C22, . . . , CN1, CN2) can be configured in the second stage (stage 2) to the N stage (stage N).

Here, as discussed with reference to FIG. 18, each of the base switch networks (SN21, SN22, SN23, SN24, . . . , SNN1, SNN2, SNN3, SNN4) can include a first switch S1 connected between a first node N1 and a second node N2 and a second switch S2 connected between a third node N3 and a reference voltage. Further, at least one of capacitors configured in an identical stage can be connected between the second node N2 and the third node N3.

In addition, each of four base switch networks configured in a kth stage (k is one of 2, 3, . . . , N) can be independently connected to one terminal of two capacitors of a (k−1)th stage that is the previous stage so that at least two of the four base switch networks cannot be commonly connected to one terminal of the two capacitors. Respective two of the four base switch networks configured in the kth stage (k is one of 2, 3, . . . , N) can share a capacitor with each other.

An output switch network SNT can be configured in the output stage (output stage). The output switch network SNT can include two output switch network modules SNT1 and SNT2.

Specifically, the output switch network SNT can include four switches, a first terminal of each of which can be independently connected to one terminal of two capacitors CN1 and CN2 of the Nth stage so that at least two first terminals of the four switches cannot be commonly connected to one terminal of the two capacitors CN1 and CN2. Respective second terminals of the four switches of the output switch network SNT can be commonly connected to an output terminal.

Thus, the switch capacitor converter 2200 generalized to have an N number of stages and one output stage can operate in the voltage conversion ratio of 2^{N}:1. Further, integrating or sharing capacitors and switches of two switch capacitor converter modules can result in a size of the switch capacitor converter 2200 being reduced, and using the interleaving manner can allow ripples of voltages or currents that are input or output to be reduced. Since the voltage conversion ratio of the switch capacitor converter 2200 increase two times as one stage is added, it is possible to implement a high voltage conversion ratio while employing a smaller number of components.

As discussed above, in accordance with the embodiments of the present disclosure, it is possible to provide a switch capacitor converter with high efficiency and a small size. In accordance with the embodiments of the present disclosure, it is possible to provide a switch capacitor converter capable of adjusting a conversion ratio of an input voltage to an output voltage. In accordance with the embodiments of the present disclosure, it is possible to provide a switch capacitor converter that is configured in a binary manner and can be extended to have a higher voltage conversion ratio. In accordance with the embodiments of the present disclosure, it is possible to provide a switch capacitor converter which operates, in an interleaving manner, two switch capacitor converter modules that are connected in parallel and enables capacitors between the two modules to be integrated or shared.

Further, unless otherwise specified herein, terms ‘include,’ ‘comprise,’ ‘constitute,’ ‘have,’ and the like described herein mean that one or more other configurations or elements may be further included corresponding configuration or element. Unless otherwise defined herein, all the terms used herein including technical and scientific terms have the same meaning as those understood by those skilled in the art. The terms generally used such as those defined in dictionaries should be construed as being the same as the meanings in the context of the related art and should not be construed as being ideal or excessively formal meanings, unless otherwise defined herein.

Although a preferred embodiment of the present disclosure has been described for illustrative purposes, those skilled in the art will appreciate that various modifications, additions and substitutions are possible, without departing from the scope and spirit of the invention as disclosed in the accompanying claims. Although the exemplary embodiments have been described for illustrative purposes, a person skilled in the art will appreciate that various modifications and applications are possible without departing from the essential characteristics of the present disclosure. For example, the specific components of the exemplary embodiments may be variously modified. The scope of protection of the present disclosure should be construed based on the following claims, and all technical ideas within the scope of equivalents thereof should be construed as being included within the scope of the present disclosure.

What is claimed is:

1. A converter receiving an input voltage through an input terminal and supplying an output voltage through an output terminal, comprising:
a first switch capacitor network in which i) a first switch, a first capacitor, and a second switch are connected in series, ii) a first terminal of the first switch is connected to the input terminal, and iii) a second terminal of the second switch is connected to a reference voltage;
a second switch capacitor network in which i) a third switch, a second capacitor, and a fourth switch are connected in series, ii) a first terminal of the third switch is connected to a first terminal of the first capacitor, and iii) a second terminal of the fourth switch is connected to the reference voltage;
a third switch capacitor network in which i) a fifth switch, a third capacitor, and a sixth switch are connected in series, ii) a first terminal of the fifth switch is connected to a second terminal of the first capacitor, and iii) a second terminal of the sixth switch is connected to the reference voltage; and
an output switch network including a seventh switch and an eighth switch which are connected in series and a ninth switch and a tenth switch which are connected in series, in which i) a first terminal of the seventh switch and a second terminal of the eighth switch are connected to both terminals of the second capacitor respectively, ii) a first terminal of the ninth switch and a second terminal of the tenth switch are connected to both terminals of the third capacitor respectively, and iii) a connection point of the seventh switch and the eighth switch and a connection point of the ninth switch and the tenth switch are connected together to the output terminal.

2. The converter according to claim 1, wherein a ratio of the input voltage to the output voltage is changeable during an operation of the converter.

3. The converter according to claim 1, wherein in a first state of a 4:1 mode, the first, fourth, fifth, seventh, and tenth switches are turned on, and the second, third, sixth, eighth, and ninth switches are turned off, and in a second state of the 4:1 mode, the second, third, sixth, eighth, and ninth switches are turned on, and the first, fourth, fifth, seventh, and tenth switches are turned off,
wherein the converter operates so that a ratio of the input voltage to the output voltage substantially becomes 4:1.

4. The converter according to claim 1, wherein in a first state of a 3:1 mode, the first, fifth, and tenth switches are turned on, and the second, third, fourth, sixth, seventh, eighth, and ninth switches are turned off, and in a second state of the 3:1 mode, the second, third, sixth, seventh, and ninth switches are turned on, and the first, fourth, fifth, eighth, and tenth switches are turned off,
wherein the converter operates so that a ratio of the input voltage to the output voltage substantially becomes 3:1.

5. The converter according to claim 1, wherein in a first state of a 2:1 mode, the first, third, fifth, eighth, and ninth switches are turned on, and the second, fourth, sixth, seventh, and tenth switches are turned off, and in a second state of the 2:1 mode, the second, third, fourth, and seventh switches are turned on, and the first, fifth, sixth, eighth, ninth, and tenth switches are turned off,
wherein the converter operates so that a ratio of the input voltage to the output voltage substantially becomes 2:1.

6. A converter receiving an input voltage through an input terminal and supplying an output voltage through an output terminal, comprising:
a first capacitor;
a second capacitor;
a third capacitor; and
a switch network for changing a connection relationship between the input terminal, the output terminal, the first capacitor, the second capacitor, and the third capacitor,
wherein a ratio of the input voltage to the output voltage is selectable from 4:1, 3:1, or 2:1 depending on an operation of the switch network.

7. The converter according to claim 6, wherein in a first state of the 4:1 mode, i) a first terminal of the first capacitor is connected to the input terminal, ii) a second terminal of the first capacitor is connected to a first terminal of the third capacitor, iii) a second terminal of the third capacitor is connected to a first terminal of the second capacitor and the output terminal, and iv) a second terminal of the second capacitor is connected to a reference voltage, and in a second state of the 4:1 mode, i) the first terminal of the first capacitor is connected to the first terminal of the second capacitor, ii) the second terminal of the first capacitor is connected to the reference voltage, iii) the second terminal of the second capacitor is connected to the first terminal of the third capacitor and the output terminal, and iv) the second terminal of the third capacitor is connected to the reference voltage,
wherein the converter operates so that a ratio of the input voltage to the output voltage substantially becomes 4:1.

8. The converter according to claim 6, wherein in a first state of the 3:1 mode, i) a first terminal of the first capacitor is connected to the input terminal, ii) a second terminal of the first capacitor is connected to a first terminal of the third capacitor, iii) and a second terminal of the third capacitor is connected to the output terminal, and in a second state of the 3:1 mode, i) the first terminal of the first capacitor and the first terminal of the third capacitor is connected to the output terminal, ii) and the second terminal of the first capacitor and the second terminal of the third capacitor are connected to the reference voltage,
wherein the converter operates so that a ratio of the input voltage to the output voltage substantially becomes 3:1.

9. The converter according to claim 6, wherein in a first state of the 2:1 mode, i) a first terminal of the first capacitor and a first terminal of the second capacitor are connected to the input terminal, ii) and a second terminal of the first capacitor and a second terminal of the second capacitor are connected to the output terminal, and in a second state of the 2:1 mode, i) the first terminal of the first capacitor and the first terminal of the second capacitor are connected to the output terminal, ii) and the second terminal of the first capacitor and the second terminal of the second capacitor are connected to the reference voltage,
wherein the converter operates so that a ratio of the input voltage to the output voltage substantially becomes 2:1.

10. The converter according to claim 6, wherein a ratio of the input voltage to the output voltage is changeable during an operation of the converter.

11. A converter receiving an input voltage through an input terminal and supplying an output voltage through an output terminal, comprising:
a first switch, a second switch, a third switch, a fourth switch, a fifth switch, a sixth switch, a seventh switch, an eighth switch, a ninth switch, and a tenth switch; and
a first capacitor, a second capacitor, and a third capacitor,
wherein in the converter, i) a first terminal of the first switch is connected to the output terminal, ii) a second terminal of the first switch is connected to a first terminal of the first capacitor and a first terminal of the third switch, iii) a second terminal of the first capacitor is connected to a first terminal of the second switch and a first terminal of the fifth switch, iv) a second terminal of the fifth switch is connected to a first terminal of the third capacitor and a first terminal of the ninth switch, v) a second terminal of the third capacitor is connected to a first terminal of the sixth switch and a second terminal of the tenth switch, vi) a second terminal of the ninth switch is connected to a first terminal of the tenth switch, the output terminal, a second terminal of the seventh switch, and a first terminal of the eighth switch, vii) a second terminal of the third switch is connected to a first terminal of the seventh switch and a first terminal of the second capacitor, viii) a second terminal of the second capacitor is connected to a second terminal of the eighth switch and a first terminal of the fourth switch, and ix) a second terminal of the second switch, a second terminal of the sixth switch, and a second terminal of the fourth switch are connected to the reference voltage.

12. The converter according to claim 11, wherein a plurality of switching components in at least one of the first to tenth switches is connected in series and/or in parallel.

13. The converter according to claim 11, wherein a plurality of capacitors in at least one of the first to third capacitors is connected in series and/or in parallel.

14. A converter receiving an input voltage through an input terminal and supplying an output voltage through an output terminal, comprising:
a first switch capacitor converter module including a switch and a capacitor; and
a second switch capacitor converter module including a switch and a capacitor and sharing the input terminal and the output terminal with the first switch capacitor converter module.

15. The converter according to claim 14, wherein the first switch capacitor converter module and the second switch capacitor converter module are configured with an equal circuitry to each other and operate in an interleaving manner.

16. The converter according to claim 14, wherein the first switch capacitor converter module and the second switch capacitor converter module share at least one capacitor and/or at least one switch with each other.

17. The converter according to claim 14, wherein each of the first switch capacitor converter module and the second switch capacitor converter module comprise:
a first switch capacitor network in which i) a first switch, a first capacitor, and a second switch are connected in series, ii) a first terminal of the first switch is connected to the input terminal, and iii) a second terminal of the second switch is connected to a reference voltage;
a second switch capacitor network in which i) a third switch, a second capacitor, and a fourth switch are connected in series, ii) a first terminal of the third switch is connected to a first terminal of the first capacitor, and iii) a second terminal of the fourth switch is connected to the reference voltage;
a third switch capacitor network in which i) a fifth switch, a third capacitor, and a sixth switch are connected in series, ii) a first terminal of the fifth switch is connected to a second terminal of the first capacitor, and iii) a second terminal of the sixth switch is connected to the reference voltage; and
an output switch network including a seventh switch and an eighth switch which are connected in series and a ninth switch and a tenth switch which are connected in series, in which i) a first terminal of the seventh switch and a second terminal of the eighth switch are connected to one terminal and the other terminal of the second capacitor respectively, ii) a first terminal of the ninth switch and a second terminal of the tenth switch are connected to both terminals of the third capacitor respectively, and iii) a connection point of the seventh switch and the eighth switch and a connection point of the ninth switch and the tenth switch are connected together to the output terminal.

18. The converter according to claim 17, wherein a line for connecting the second capacitor of the first switch capacitor converter module and the third capacitor of the second switch capacitor converter module in parallel is added between the first switch capacitor converter module and the second switch capacitor converter module,
wherein at least one of integration of the second capacitor of the first switch capacitor converter module and the third capacitor of the second switch capacitor converter module, integration of the seventh switch of the first switch capacitor converter module and the ninth switch of the second switch capacitor converter module, and integration of the eighth switch of the first switch capacitor converter module and the tenth switch of the second switch capacitor converter module is applied to the converter.

19. The converter according to claim 17, wherein a line for connecting the third capacitor of the first switch capacitor converter module and the second capacitor of the second switch capacitor converter module in parallel is added between the first switch capacitor converter module and the second switch capacitor converter module,
wherein at least one of integration of the third capacitor of the first switch capacitor converter module and the second capacitor of the second switch capacitor converter module, integration of the ninth switch of the first switch capacitor converter module and the seventh switch of the second switch capacitor converter module, and integration of the tenth switch of the first switch capacitor converter module and the eighth switch of the second switch capacitor converter module is applied to the converter.

20. A converter receiving an input voltage through an input terminal and supplying an output voltage through an output terminal, the converter comprising:
an N number of stages; and
an output stage,
wherein the converter operates so that a ratio of the input voltage to the output voltage becomes 2^{N}:1,
wherein i) two base switch networks and two capacitors are configured in a first stage of the N number of stages, ii) four base switch networks and two capacitors are configured in each of a second stage to an Nth stage of the N number of stages, iii) an output switch network is configured in the output stage, iv) each of the base switch networks includes a first switch connected between a first node and a second node and a second switch connected between a third node and a reference voltage, and v) at least one of capacitors included in an identical stage is connected between the second node and the third node.

21. The converter according to claim 20, wherein each of four base switch networks configured in a kth stage (k is one of 2, 3, . . . , N) is independently connected to one terminal of two capacitors of a (k−1)th stage so that at least two of the four base switch networks are not commonly connected to one terminal of the two capacitors.

22. The converter according to claim 20, wherein respective two of the four base switch networks configured in the kth stage share a capacitor with each other.

23. The converter according to claim 20, wherein the output switch network includes four switches,
wherein a first terminal of each of the four switches of the output switch network is independently connected to one terminal of two capacitors of the Nth stage so that at least two terminals of the four switches are not commonly connected to one terminal of the two capacitors of the Nth stage, and respective second terminals of the four switches of the output switch network are commonly connected to the output terminal.
